(19) United States
(12) Patent Application Publication
(10) Pub. No.: US 2011/0197139 A1
(43) Pub. Date: Aug. 11, 2011

(54) Displaying Personalized Information in a Handheld Device

(75) Inventors: Bernardo Huberman, Palo Alto, CA (US); Scott A. Golder, Palo Alto, CA (US); Fang Wu, Palo Alto, CA (US)

(73) Assignee: HEWLETT-PACKARD DEVELOPMENT COMPANY. L.P., Houston, TX (US)

(21) Appl. No.: 13/123,548

(22) PCT Filed: Nov. 5, 2008
(86) PCT No.: PCT/US2008/082497

§ 371 Date: Apr. 11, 2011

(51) Int. Cl. G06F 3/01; G06F 15/16

(52) U.S. Cl. 715/738

(57) ABSTRACT

One embodiment is a handheld electronic device (600) that has a display (610) with plural icons (620A-620D) that represent subscriptions to information provided by a server (110) upon activation of the icons. The information is selected from a user with a computer that is separate from the handheld electronic device.

### FIELD OF THE INVENTION

The present invention relates to displaying personalized information with widgets and/or icons on a handheld device.

### BACKGROUND

Mobile workers and consumers often require access to timely personalized information without resorting to relatively larger computing devices, such as laptop and desktop computers. In order to access such information, handheld mobile devices store personal information and enable users to access the internet.

Accessing and obtaining information over the internet with a handheld device can require numerous steps and be time-consuming. A user may first have to open a web browser on the handheld device and then navigate through several web pages to find the desired information. Furthermore, this information may be spread across various different websites. For example, if the user is seeking information on stocks, sports scores, and weather conditions, the user would have to navigate to multiple different sites. If this information is frequently requested, then the user would have to repeatedly navigate to these sites.

### BRIEF DESCRIPTION OF THE DRAWINGS

FIG. 1 shows a computer system in accordance with an exemplary embodiment of the present invention.

FIG. 2 shows a flow diagram for adding subscriptions to personalized information in accordance with an exemplary embodiment of the present invention.

FIG. 3 shows a screen shot of a program for managing subscriptions to personalized information in accordance with an exemplary embodiment of the present invention.

FIG. 4 shows a flow diagram for installing software and adding subscriptions to a handheld device in accordance with an exemplary embodiment of the present invention.

FIG. 5 shows a flow diagram for displaying subscriptions to personalized information in accordance with an exemplary embodiment of the present invention.

FIG. 6 shows a handheld device having a display with multiple subscriptions in accordance with an exemplary embodiment of the present invention.

FIG. 7 shows a handheld device in accordance with an exemplary embodiment of the present invention.

### DETAILED DESCRIPTION

Exemplary embodiments relate to systems and methods for quickly displaying personalized information in a handheld mobile device. Personalized information is displayed with or accessible from activation of one or more widgets or icons provided on the display of the handheld device.

With exemplary embodiments, users have full and immediate access to their personal information. This information can be obtained without requiring a user to navigate through multiple websites or type data into their handheld device. Instead, personal information is contemporaneously or simultaneously displayed with an icon on the handheld device and/or provided when a user initiates a single activation of the icon.

By way of example, exemplary embodiments can be used by mobile workers and consumers who frequently require access to timely personalized information. This information can be accessed and obtained over a network, such as the internet, with activation of a single widget or icon located on a display of the handheld device. Automatic updates are provided so the information remains current.

When a user activates the widget or icon, personalized information is immediately displayed to the user. The user is not required to perform numerous steps, such as opening a web browser on the handheld device and typing data or clicking multiple hyperlinks to navigate through several web pages to find the desired information. Instead, the desired information is presented on the display of the handheld device with a single activation, such as a single click of a widget or icon. Furthermore, even if this information is spread across various different websites, a user can quickly access this information.

In one embodiment, personalized information is displayed on the handheld device without requiring the user to perform any steps or activation. In other words, a user is not required to perform any actions (such as clicking a hyperlink, typing data, using menus, navigating to websites, etc.) to view requested information. Instead, the information is presented on the display with the widget or icon. Personalized information is contemporaneously displayed adjacent to, on, or with a widget or icon on the display. The following examples are provided to illustrate this embodiment: a weather icon includes the temperature for a selected city, a sports icon includes a score for a selected sports team, a stock icon includes a stock quote for a selected stock, a transportation icon includes information on an airline flight, a sales icon includes current sales data, etc.

Icons and accompanying information are not limited to any particular type of personalized information but include any information that can be succinctly displayed with or next to an icon or widget on a display of a handheld or mobile computing device.

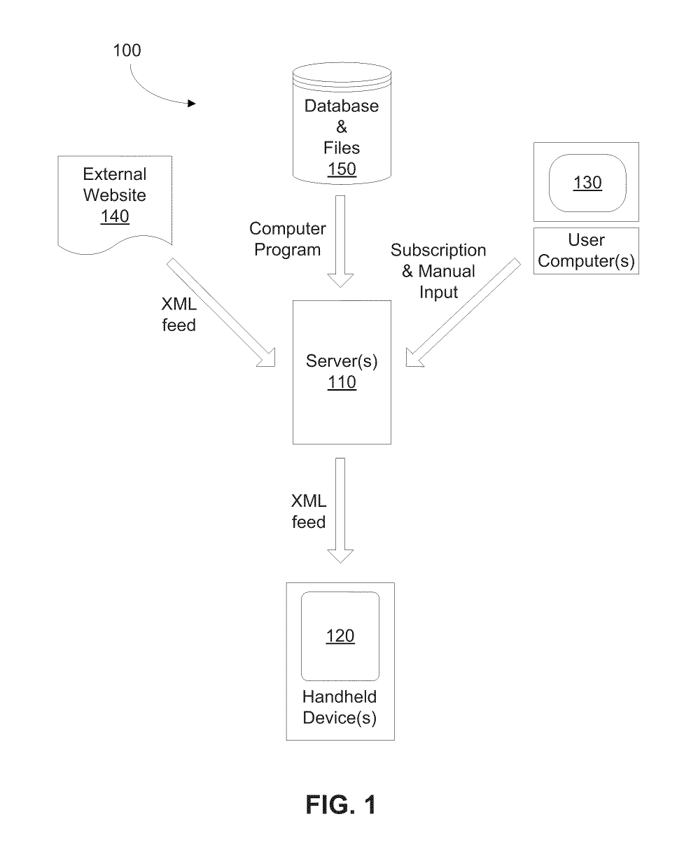

FIG. 1 shows a computer system 100 in accordance with an exemplary embodiment of the present invention. The system enables users to configure and display personalized or tracking information on handheld or mobile devices. The architecture of the system includes three main components: one or more servers 110, handheld devices 120, and personal/public computers 130. One or more external websites 140 and a database and files 150 are in communication with the servers 110. The external web servers provide XML (Extensible Markup Language) feeds to the servers 110 and then to the handheld devices 120.

The servers 110 provide users or customers with a number of standard channels, such as flight tracker, stock price monitor, weather monitor, real-time score board, etc. Users configure and subscribe to these channels through a website from a user computer 130. Later, after installing a client program on a handheld device 120, personalized information pertaining to a user-selected subscription is automatically provided to the handheld device without further configuration. The handheld device retrieves the display data from a feed URL (Uniform Resource Locator) hosted by a supporting external website 140 at the servers 110, via GPRS (General Packet Radio Service), WI-FI, or other communication technologies. Alternatively, the user can dial a public phone number that would vocally read the data for the user.

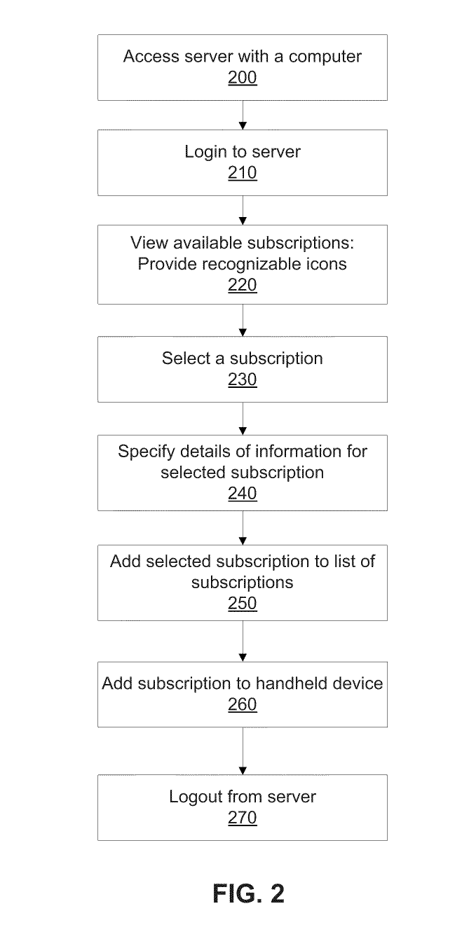

At least four different ways exists to specify a new subscription to a channel (i.e., a tracker). First, subscriptions to standard channels can be added directly from the server's website (discussed in more detail in connection with FIG. 2). Second, subscriptions to third-party channels (provided by other websites) can also be added from the supporting website by specifying an external feed URL. Third, a number of computer programs are provided for the users to track file and database changes on their personal computers. Changes are automatically detected and reported to the servers 110, and these changes can be subsequently tracked on handheld devices 120. Fourth, users can input data manually through the supporting website.

The system of FIG. 1 provides access to timely and relevant information that is updated without any input from the user. Users can further access the supporting website with a computer and configure the information that will be displayed on the handheld device. Personal information being tracked and displayed on the handheld device is thus configured from a laptop computer, desktop computer, or other electronic device.

FIG. 2 shows a flow diagram for adding subscriptions to personalized information in accordance with an exemplary embodiment of the present invention.

According to block 200, a user accesses a server with a computer. For example, using a user computer 130 of FIG. 1, a user navigates to a supporting webpage hosted by one of the servers 110.

According to block 210, the user logs in to the server. For example, the user enters one or more of a user name, identification, telephone number, or password.

According to block 220, a user views available subscriptions. The subscriptions, for example, can be provided as user recognizable icons or widgets.

According to block 230, the user selects one or more subscriptions from a list of available subscriptions.

According to block 240, the user specifies details of information for the selected subscription. Here, the user provides information to personalize the selected subscription. Subscription information is tailored or personalized for the user. For example, if the subscription is a stock quote, the user enters the name of the company for which stock quotes are requested.

According to block 250, the selected subscription is added to the user's list of subscriptions. For example, the user can drag-n-drop the icon to a list of a subscriptions, click an add button, use a menu to add the subscription, etc. The subscription is automatically added to the user's subscription list which is stored in a server or storage device (such as server 110 or database 150 of FIG. 1).

According to block 260, the selected subscription is automatically added to the handheld device of the user. An icon representing the selected subscription appears on the display of the handheld device.

According to block 270, once a user finishes managing subscriptions, the user logs outs from the server.

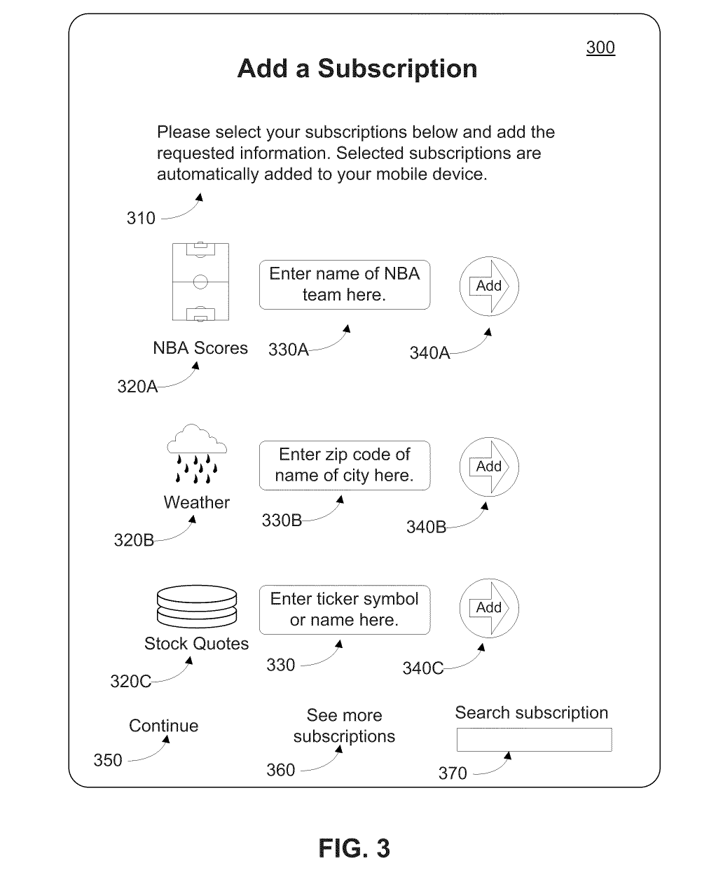

FIG. 3 shows a screenshot 300 from a program for managing subscriptions to personalized information in accordance with an exemplary embodiment of the present invention. The program enables a user to manage subscriptions, such as adding new subscriptions, deleting subscriptions, modifying personal information about a subscription, creating new subscription accounts for handheld devices, etc.

For illustration, the screenshot 300 corresponds to steps 220 to 250 of FIG. 2.

The user is instructed at 310 to select a displayed subscription and add the requested information to form a personalized subscription. Selected subscriptions are automatically added as icons or widgets to the display of the user's handheld device.

By way of example, screenshot 300 shows three different subscriptions 320A, 320B, and 320C. Each of these subscriptions includes a data entry box 330A, 330B, and 330C. The user enters the personalized information about a subscription into the respective data entry box and then activates the subscription. The user clicks a respective add button 340A, 340B, or 340C to activate and add the personalized subscription to the user's handheld device.

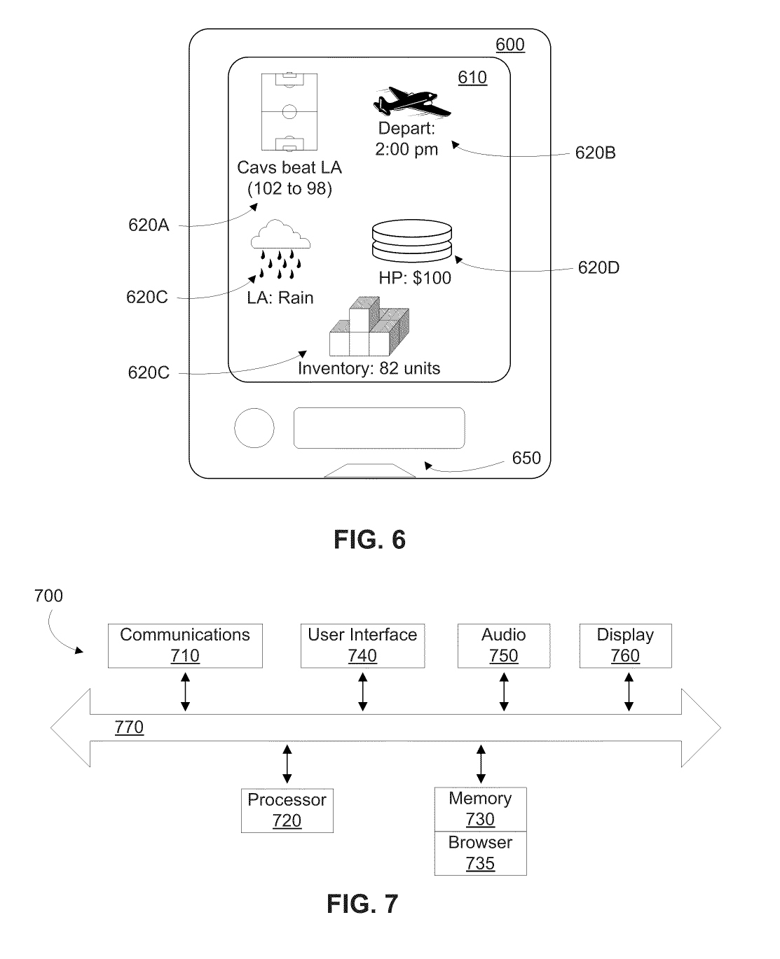

Subscription 320A is an NBA (National Basketball Association) subscription. The user enters a favorite NBA team (such as the Los Angeles Lakers) into box 330A and clicks the add button 340A. A subscription to scores for the Los Angeles Lakers is then automatically added to the user's subscription list which is stored in a server or storage device (such as server 110 or database 150 of FIG. 1). A user recognizable NBA icon (see icon 620A in FIG. 6) automatically appears on the user's handheld device. The icon includes scores of the latest NBA game for the LA Lakers and/or a hyperlink to such scores.

Subscription 320B is a weather subscription. The user enters a city (such as the Los Angeles) into box 330B and clicks the add button 340B. A subscription to weather for the Los Angeles is then automatically added to the user's subscription list which is stored in a server or storage device (such as server 110 or database 150 of FIG. 1). A user recognizable weather icon (see icon 620C in FIG. 6) automatically appears on the user's handheld device. The icon includes current or forecasted weather for Los Angeles and/or a hyperlink to detailed weather conditions and forecasts.

Subscription 320C is a stock quote subscription. The user enters a ticker symbol or company name (such as HP or Hewlett-Packard Company) into box 330C and clicks the add button 340C. A subscription to stock quotes for Hewlett-Packard Company is then automatically added to the user's subscription list which is stored in a server or storage device (such as server 110 or database 150 of FIG. 1). A user recognizable stock icon (see icon 620C in FIG. 6) automatically appears on the user's handheld device. The icon includes current stock quotes for Hewlett-Packard Company and/or a hyperlink to detailed stock information for the company.

The screenshot 300 can include a variety of other options which enable the user to enter personalized information about a subscription or navigate through the program. Some additional options are provided for illustration, such as “continue” to next page 350, “see more subscriptions” 360, and a “search subscriptions” box 370 for searching available subscriptions.

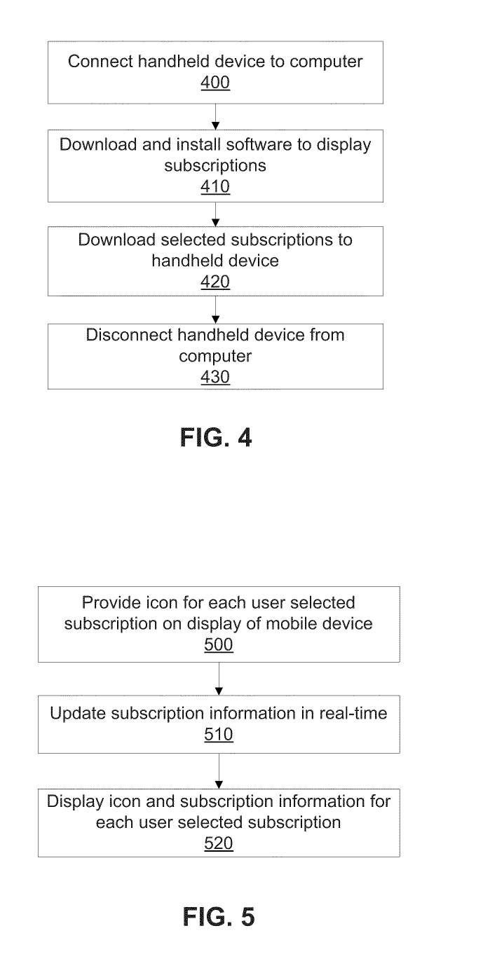

FIG. 4 shows a flow diagram for installing software and adding subscriptions to a handheld device in accordance with an exemplary embodiment of the present invention.

According to block 400, a user connects or couples a handheld device to a computer. This connection is made so the handheld device can download a software program for supporting subscriptions provided to the handheld device. The computer can be a personal computer (such as computer 130 of FIG. 1) storing the program, or the user can connect to one of more of the servers (such as servers 110 of FIG. 1) storing or accessing the program.

According to block 410, the user downloads and installs the program to the handheld device so subscriptions and corresponding icons can be displayed.

According to block 420, the selected subscriptions are downloaded to the handheld device. For example, the subscriptions selected in steps 230 to 260 of FIG. 2 are added to the handheld device.

According to block 430, the user disconnects or terminates the communication connection between the handheld device and the computer.

While the user can download and install the handheld software program from the computer (as shown in block 410), the program can also be directly downloaded from the Internet through GPRS (General Packet Radio Service), WI-FI, or other connections. Also, once the user inputs a user identification (for example, a phone number), the program can download all subscriptions from the Internet server without connecting to a computer. Alternatively, the user can elect to download everything from a computer.

FIG. 5 shows a flow diagram for displaying subscriptions to personalized information in accordance with an exemplary embodiment of the present invention.

According to block 500, an icon is provided for each user selected subscription on a display of a handheld device. For example, the subscriptions selected in steps 230 to 260 of FIG. 2 are added to the handheld device. In one embodiment, the same icon appearing in the screenshot 300 of FIG. 3 appears on the display of the handheld device. In other words, the same icon added to the subscription list with a personal computer is subsequently added to the display of the handheld device. Icons 320A, 320B, and 320C are the same as respective icons 620A, 620C, and 620D.

According to block 510, subscription information is updated in real-time. Personal information about each selected subscription is automatically updated so the user has the most current available information. For example, if the user selects stock quotes for Hewlett-Packard Company, then the stock quote icon on the display of the handheld device provides a real-time stock quote for Hewlett-Packard Company. Real-time updates are also applicable to other selected subscriptions, such as weather, sports scores, etc. Alternatively, subscription information is periodically updated or updated upon user request.

According to block 520, the selected icon and subscription information are displayed for each selected subscription. For each subscription that the user selects, the corresponding icon for the subscription is displayed on the handheld device.

FIG. 6 shows a handheld device 600 having a display 610 with multiple subscriptions in accordance with an exemplary embodiment of the present invention. By way of illustration, the display 610 includes five subscription icons 620A to 620D. Each of these icons was previously displayed to the user while the user added these subscriptions using the personal computer.

By way of example, subscription 620A represents an NBA (National Basketball Association) subscription. Since the user previously entered the Los Angeles Lakers to personalize the subscription information, the current score of the Los Angeles Lakers is displayed to the user with the icon.

Subscription 620B represents a flight icon that shows the current status of a user selected airline flight. Subscription 620C is a weather icon. Since the user previously entered the city of Los Angeles to personalize the subscription information, the current weather for Los Angeles is displayed to the user with the icon. Subscription 620D is a stock icon. Since the user previously entered Hewlett-Packard Company to personalize the subscription information, the current stock price of Hewlett-Packard Company is displayed to the user with the icon. Subscription 620E is an inventory icon. This icon shows a current inventory for goods, such as goods in a warehouse.

The handheld device 600 includes various buttons, controls, or user interface functions 650 for enabling the user to interact with the handheld device. The handheld device is a wireless device that communicates using, for example, radio frequency (RF) signals, infrared, etc.

FIG. 7 shows a handheld device 700 in accordance with an exemplary embodiment. The handheld device 700 includes a communication system 710, processor 720, memory 730, user interface 740, audio components 750, and display 760 coupled together along a bus 770. The processor or processing unit 720 (such as one or more processors or central processing units, CPUs) controls the overall operation of the device 700. The memory 730 (such as random access memory (RAM) for temporary data storage and read only memory (ROM) for permanent data storage) stores data, control programs, one or more browsers 735, applications, programs, audio and video files, and other data associate with the handheld device. The processor communicates with the memory and other components via one or more buses 770.

In one exemplary embodiment, the communication system 710 includes systems for communicating using one or more media, such as infrared, RF, radio waves (example, wireless WLAN/LAN), and other wireless signals (example, various signals for communicating with wireless networks). For instance, the communication system 710 includes a cellular phone communication system interface that facilitates radio frequency (RF) communications to a cellular base station. When a communication is sent from the cellular device to a base station, the communication system 710 or communication interface formats the communication into a format suitable for broadcasting, such as RF signals. Likewise, when a communication is sent to the cellular device from a base station, the communication system 710 or communication interface formats the communication into a format suitable for further processing by other components residing in the cellular device. Communications transmitted to and received at the cellular device 700 include audio data, video data, and other data and information.

The handheld device 700, though, is not limited to transmitting and receiving RF signals. Other types of signals can also be used to transmit video, audio, and other data. The communication system 710 is configured to receive a variety of signals and convert those signals to an appropriate format for further communication to other devices and displays. The handheld device supports two-way communications with various other electronic devices. Further, the handheld device can simultaneously communicate using multiple different communication signals or media. For instance, the communication system 710 includes interfaces for concurrently communicating with a tower using RF and/or with another electronic device using infrared, radio waves (example, wireless WLAN/LAN), and/or wireless transmissions to connect to a network (such as the internet via a home or office network).

The memory 730 can also include one or more browsers 735 that are software applications used to locate, navigate, and display information (such as web pages) over networks (such as the internet). Graphical browsers display graphics and text and present multimedia information. The multimedia information, for example, includes text, graphics, video, sound, and animation. Further, the memory 730 can include various off-the-shelf software programs, such as those available on a notebook or desktop computer. In this manner, the handheld device is multifunctional and enables users to enter and manipulate data and information (example, using word processing programs or tools).

The user interface 740 is a medium for providing instructions from the user to the processor, browser, etc. For instance, the user can manipulate a keypad to interact with the handheld device. Thus, the user interface 740 receives information or commands from the user to control operations of the handheld device.

In one exemplary embodiment, each icon represents a unique application. A query to the application (such as a user click on the icon) activates the application to retrieve current information for the personalized subscription. A user is able to retrieve the information with a single activation, for example a single mouse click, single touch of the display, etc. All information for each icon is stored on a single server to enhance availability and storage.

In one exemplary embodiment, widgets and/or icons are provided to the user so the user can display user-selected specific information pertaining to the subject matter of the widget or icon. To accomplish this, exemplary embodiments do not need to open up a whole set of programming libraries to allow third-party programmers to create their own widgets. The following example illustrates this notion. Let's say a sales manager wants his employees to have access to some real-time sales data. All he needs to do is to set up a data feed on any server (just like setting up an RSS feed which is many times easier than writing a real widget), and let his employees subscribe to that feed from the server of exemplary embodiments. The employees will then automatically receive the sales data on their mobile devices without doing any work on the device.

Definitions

As used herein and in the claims, the following words are defined as follows:

An “icon” refers to a picture or symbol on a graphical user interface (GUI) that represents an object or a program. Icons can also display textual information associated with the icon itself.

A “widget” refers to a graphical user interface (GUI) that displays changeable information in the form of, for example, a window, text box, symbol, or icon. Widgets provide a single interaction point for retrieving or manipulating data

In one exemplary embodiment, one or more blocks or steps discussed herein are automated. In other words, apparatus, systems, and methods occur automatically. The terms “automated” or “automatically” (and like variations thereof) mean controlled operation of an apparatus, system, and/or process using computers and/or mechanical/electrical devices without the necessity of human intervention, observation, effort and/or decision.

The methods in accordance with exemplary embodiments of the present invention are provided as examples and should not be construed to limit other embodiments within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method, comprising:
receiving, at a server from a personal computer, information to add a subscription on a handheld device of a user (230);
adding an icon that represents the subscription on the handheld device (500); and
providing, by the server, the handheld device with information pertaining to the subscription upon activation of the icon by the user (520).

2) The method of claim 1 further comprising, displaying a subscription icon to the user on the personal computer when the user adds the subscription to the handheld device, wherein subscription icon and the icon have a same appearance to the user.

3) The method of claim 1 further comprising:
receiving, at the server from the personal computer, personalized information from the user about the subscription;
displaying, on the handheld device, the personalized information about the subscription upon receiving a single activation of the icon.

4) The method of claim 1 further comprising, displaying real-time information about the subscription simultaneously with the icon on a display of the handheld device.

5) The method of claim 1 further comprising:
receiving, at the server from an external website, updated information about the subscription;
transmitted the updated information from the server to the handheld device upon activation of the icon by the user.

6) A tangible computer readable storage medium having instructions for causing a computer to execute a method, comprising:
displaying, on a mobile telephone, an icon that represents a subscription to information provided by a server (500); and
displaying, after a single activation of the icon, information pertaining to the subscription on the mobile telephone, wherein the information pertaining to the subscription is selected from a user with a computer that is separate from the mobile telephone (520).

7) The tangible computer readable storage medium of claim 6 further comprising, contemporaneously displaying textual information with the icon, the textual information being personalized to the user.

8) The tangible computer readable storage medium of claim 6, wherein the icon is an application that requests the information pertaining to the subscription from the server.

9) The tangible computer readable storage medium of claim 6, wherein the icon is configured from the computer to include personalized information selected by the user.

10) The tangible computer readable storage medium of claim 6, wherein the user logs on to a website with the computer to add the subscription to the mobile telephone.

11) A handheld electronic device (600), comprising:
a display (610) with plural icons (620A-620D) that represent subscriptions to information provided by a server upon activation of the icons, wherein the information is selected from a user with a computer that is separate from the handheld electronic device.

12) The handheld electronic device of claim 11, wherein the plural icons displayed on the display are also displayed on the computer when the user adds the subscriptions.

13) The handheld electronic device of claim 11, wherein the plural icons include textual information that is updated in real-time and contemporaneously displayed with the plural icons on the display.

14) The handheld electronic device of claim 11, wherein the icon is an application that requests the information provided by the server upon being activated by the user.

15) The handheld electronic device of claim 11, wherein the icons include one of stock quotes, weather, and sports scores that are personalized by the user with the computer.
